(19) United States
(12) Patent Application Publication
(10) Pub. No.: US 2007/0291367 A1
(43) Pub. Date: Dec. 20, 2007

(54) HARD-COATED ANTIGLARE FILM, AND POLARIZING PLATE AND IMAGE DISPLAY INCLUDING THE SAME

(75) Inventors: Daisuke HAMAMOTO, Ibaraki-shi (JP); Hiroyuki TAKAO, Ibaraki-shi (JP); Yuuichi KIMURA, Osaka (JP); Katsunori TAKADA, Osaka (JP); Seiichi KUSUMOTO, Ibaraki-shi (JP); Takayuki SHIGEMATSU, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/762,991

(22) Filed: Jun. 14, 2007

(30) Foreign Application Priority Data
Jun. 15, 2006 (JP) 2006-166747

(51) Int. Cl. G02B 27/00

(52) U.S. Cl. 359/601

(57) ABSTRACT

A hard-coated antiglare film is provided that is excellent in antiglare properties and image sharpness and that can prevent glare from occurring. The hard-coated antiglare film includes a transparent plastic film substrate and a hard-coating antiglare layer that is formed on at least one surface of the transparent plastic film substrate and that is formed of fine particles and a curable hard-coating resin. The hard-coating antiglare layer has a thickness in the range of 20 to 30 μm. The fine particles have a weight average particle size in the range of 7 to 15 μm. The difference obtained by subtracting the refractive index of the fine particles from that of the curable hard-coating resin that has been cured is in the range of −0.06 to −0.01 or 0.01 to 0.06.

### CROSS-REFERENCE TO RELATED APPLICATIONS

This application claims priority from Japanese Patent Application No. 2006-166747, filed on Jun. 15, 2006. The entire subject matter of the Japanese Patent Application is incorporated herein by reference.

### FIELD OF THE INVENTION

The present invention relates generally to hard-coated antiglare films, and polarizing plates and image displays including the same.

### BACKGROUND OF THE INVENTION

With technical improvement in recent years, liquid crystal displays (LCDs), plasma display panels (PDPs), electroluminescence displays (ELDs), etc. have been developed in addition to conventional cathode ray tubes (CRTs) as image displays and have been used in practical applications. As LCDs have been technically improved to provide wide viewing angles, high resolution, high response, good color reproduction, and the like, applications of LCDs are spreading from laptop personal computers and monitors to television sets. In a basic LCD structure, a pair of flat glass substrates each provided with a transparent electrode are opposed via a spacer to form a constant gap, between which a liquid crystal material is placed and sealed to form a liquid crystal cell, and a polarizing plate is formed on the outside surface of each of the pair of glass substrates. In a conventional technique, a glass or plastic cover plate is attached to the surface of the liquid crystal cell in order to prevent scratches on the polarizing plate bonded to the surface of the liquid crystal cell. However, the placement of such a cover plate is disadvantageous in terms of cost and weight. Thus, the implementation of a hard coating process to treat the surface of polarizing plates has been gradual. For the hard-coating treatment, generally, a hard-coated antiglare film having a hardness that is not lower than a certain level is used while also serving to prevent glare of LCDs and reflection of a light source onto LCDs.

A hard-coated antiglare film is used in which a thin hard-coating antiglare layer with a thickness of 2 to 10 μm has been formed on one or both surfaces of a transparent plastic film substrate. The hard-coating antiglare layer is formed using hard-coating resins for forming a hard-coating antiglare layer such as thermosetting resins or ultraviolet (UV)-curable resins and fine particles. The surface of the hard-coating antiglare layer is provided with unevenness by the fine particles so as to provide antiglare properties. Examples of the hard-coated antiglare film having both hardness and antiglare properties include those described in JP-A Nos. 11(1999)-286083, 2000-326447, 2001-194504, and 2001-264508. On the other hand, there also are demands for hard-coated antiglare films to have antiglare properties. Examples of such hard-coated antiglare films include one described in JP-A No. 2003-4903.

JP-A No. 11-286083 discloses a hard-coated antiglare film comprising a transparent substrate film and a hard-coating antiglare layer that is formed on the transparent substrate film and mainly composed of particles with an average particle size of 0.6 to 20 μm, fine particles with an average particle size of 1 to 500 nm and a hard-coating antiglare resin. It also discloses that the thickness of the hard-coating antiglare layer is at most the particle size of the particles, preferably at most 80% of the average particle size (specifically at most 16 μm).

JP-A No. 2000-326447 discloses a hard-coated film comprising a plastic substrate film and at least one hard-coating antiglare layer formed on at least one surface of the plastic substrate film, wherein the hard-coating antiglare layer has a thickness of 3 to 30 μm, and the hard-coating antiglare layer contains inorganic fine particles with secondary particle sizes of at most 20 μm. It also discloses that the surface of the hard-coating antiglare layer is provided with unevenness so as to provide antiglare properties.

JP-A No. 2001-194504 discloses an antireflection film comprising a plastic film and a laminate that is formed on at least one surface of the plastic film and comprises a hard-coating layer and thin antireflection film layer mainly composed of a metal alkoxide and a hydrolysate thereof, wherein the hard-coating antiglare layer has an elastic modulus of 0.7 to 5.5 GPa or lower at its breaking strain. It also discloses that the hard-coating antiglare layer has a thickness of 0.5 to 20 μm and that the hard-coating antiglare layer contains fine particles with an average particle size of 0.01 to 10 μm.

JP-A No. 2001-264508 discloses an antiglare antireflection film comprising a transparent support and a laminate that is formed on the transparent support and sequentially comprises a hard-coating antiglare layer containing particles with an average particle size of 1 to 10 μm and a low-refractive-index layer with a refractive index of 1.35 to 1.49 produced with a composition containing inorganic fine particles with an average particle size of 0.001 to 0.2 μm, a hydrolysate of a photo-curable organosilane and/or a partial condensate thereof, and a fluoropolymer, wherein the antiglare antireflection film has a haze value of 3 to 20% and an average reflectance of at most 1.8% at wavelengths of 450 nm to 650 nm. It also discloses that the hard-coating antiglare layer has a thickness of 1 to 10 μm.

JP-A No. 2003-4903 discloses, as an antiglare film that prevents a failure due to glare from occurring with respect to a high definition image display with a small pixel size, an antiglare film that has an antiglare layer on a transparent support and unevenness formed of concave and convex portions at the surface thereof. The antiglare film is characterized in that a cut surface of each concave portion has an area of 1000 μm² or smaller. It also discloses that in the antiglare film, the arithmetic average surface roughness Ra is in the range of 0.05 to 1.0 μm, while the average tilt angle θa of concave portions is not more than 20°.

### SUMMARY OF THE INVENTION

However, problems in both image sharpness and glare prevention have not been solved satisfactorily in these conventional hard-coated antiglare films. That is, in order to obtain antiglare properties, it is required to allow the hard-coating layer surface to have a structure with increased unevenness to scatter light, but increased light scattering reduces image sharpness. Furthermore, decreased light scattering causes problems in deterioration in antiglare properties and occurrence of glare.

Accordingly, an object of the present invention is to provide a hard-coated antiglare film that is excellent in antiglare properties and image sharpness and that prevents glare from occurring, as well as a polarizing plate and an image display including the same.

The hard-coated antiglare film of the present invention includes a transparent plastic film substrate and a hard-coating antiglare layer that is formed on at least one surface of the transparent plastic film substrate and that is formed of fine particles and a curable hard-coating resin. The hard-coating antiglare layer has a thickness in the range of 20 to 30 μm. The fine particles have a weight average particle size in the range of 7 to 15 μm. The difference obtained by subtracting the refractive index of the fine particles from that of the curable hard-coating resin that has been cured is in the range of −0.06 to −0.01 or 0.01 to 0.06.

The polarizing plate of the present invention includes a polarizer and further includes a hard-coated antiglare film of the present invention.

An image display of the present invention includes at least one of a hard-coated antiglare film of the present invention and a polarizing plate of the present invention.

As described above, the hard-coated antiglare film of the present invention includes a hard-coating antiglare layer, and the three characteristics, i.e. the thickness of the hard-coating antiglare layer, the weight average particle size of the fine particles, and the difference in refractive index between the curable hard-coating resin that has been cured and the fine particles, are set in the respective predetermined ranges. The hard-coated antiglare film of the present invention may be excellent in both antiglare properties and image sharpness and can prevent glare from occurring effectively. Therefore an image display including a hard-coated antiglare film or polarizing plate of the present invention has excellent display properties.

### BRIEF DESCRIPTION OF THE DRAWINGS

FIG. 1 is a cross-sectional view schematically showing the structure of a hard-coated antiglare film according to one embodiment of the present invention;

FIG. 2 is a cross-sectional view schematically showing the structure of a hard-coated antiglare film according to another embodiment of the present invention;

FIG. 3 is a schematic view showing an example of the relationship among the roughness curve, height h, and standard length L; and

FIG. 4 is a graph showing the relationship between the scattering angle and light intensity in one example of the present invention.

### DESCRIPTION OF THE EMBODIMENTS

In the hard-coated antiglare film of the present invention, the ratio of the fine particles is preferably in the range of 10 to 50 parts by weight with respect to 100 parts by weight of the curable hard-coating resin.

In the hard-coated antiglare film of the present invention, the curable hard-coating resin is preferably at least one of thermosetting resin and ionizing radiation curable resin.

In the hard-coated antiglare film of the present invention, it is preferable that the fine particles each have a spherical shape.

In the hard-coated antiglare film of the present invention, it is preferable that the curable hard-coating resin contains Component A, Component B, and Component C described below:
Component A: at least one of urethane acrylate and urethane methacrylate;
Component B: at least one of polyol acrylate and polyol methacrylate; and
Component C: a polymer or copolymer that is formed of at least one of Components C1 and C2 described below, or a mixed polymer of the polymer and the copolymer,
Component C1: alkyl acrylate having an alkyl group containing at least one of a hydroxyl group and an acryloyl group, and
Component C2: alkyl methacrylate having an alkyl group containing at least one of a hydroxyl group and an acryloyl group

Preferably, the hard-coated antiglare film of the present invention further comprises an antireflection layer formed on the hard-coating antiglare layer. The antireflection layer preferably contains hollow spherical silicon oxide ultrafine particles.

Next, the present invention is described in detail. The present invention, however, is not limited by the following description.

The hard-coated antiglare film of the present invention includes a transparent plastic film substrate and a hard-coating antiglare layer formed on one or both surfaces of the transparent plastic film substrate.

The transparent plastic film substrate is not particularly limited. Preferably, the transparent plastic film substrate has a high visible-light transmittance (preferably a light transmittance of at least 90%) and good transparency (preferably a haze value of at most 1%). Examples of the material for forming the transparent plastic film substrate include polyester type polymers, cellulose type polymers, polycarbonate type polymers, acrylics type polymers, etc. Examples of the polyester type polymers include polyethylene terephthalate, polyethylenenaphthalate, etc. Examples of the cellulose type polymers include diacetyl cellulose, triacetyl cellulose (TAC), etc. Examples of the acrylic type polymers include poly methylmethacrylate, etc. Examples of the material for forming the transparent plastic film substrate also include styrene type polymers, olefin type polymers, vinyl chloride type polymers, amide type polymers, etc. Examples of the styrene type polymers include polystyrene, acrylonitrile-styrene copolymer, etc. Examples of the olefin type polymers include polyethylene, polypropylene, polyolefin that has a cyclic or norbornene structure, ethylene-propylene copolymer, etc. Examples of the amide type polymers include nylon, aromatic polyamide, etc. The material for forming the transparent plastic film substrate also contains, for example, imide type polymers, sulfone type polymers, polyether sulfone type polymers, polyether-ether ketone type polymers, polyphenylene sulfide type polymers, vinyl alcohol type polymers, vinylidene chloride type polymers, vinyl butyral type polymers, allylate type polymers, polyoxymethylene type polymers, epoxy type polymers, blend polymers of the above-mentioned polymers, etc. Among them, those having small optical birefringence are used suitably. The hard-coated antiglare film of the present invention can be used as a protective film for a polarizing plate, for example. In such a case, the transparent plastic film substrate is preferably a film formed of triacetyl cellulose, polycarbonate, an acrylic polymer, a polyolefin having a cyclic or norbornene structure, etc. In the present invention, as described below, the transparent plastic film substrate may be a polarizer itself. Such a structure does not need a protective layer of TAC or the like and provides a simple polarizing plate structure and thus allows a reduction in the number of steps for manufacturing polarizing plates or image displays and an increase in production efficiency. In addition, such a structure can provide thinner polarizing plates. When the transparent plastic film substrate is a polarizer, the hard-coating layer serves as a protective layer in a conventional manner. In such a structure, the hard-coated film also functions as a cover plate, when attached to the surface of a liquid crystal cell.

In the present invention, the thickness of the transparent plastic film substrate is not particularly limited. For example, the thickness is preferably 10 to 500 μm, more preferably 20 to 300 μm, and most suitably 30 to 200 μm, in terms of strength, workability such as handling property, and thin layer property.

The hard-coating antiglare layer is formed using the fine particles and the curable hard-coating resin. As described above, examples of the curable hard-coating resin include thermosetting resin and ionizing radiation curable resin that are cured with ultraviolet rays.

As described above, the curable hard-coating resin, for example, contains Component A, Component B, and Component C described below:
Component A: at least one of urethane acrylate and urethane methacrylate;
Component B: at least one of polyol acrylate and polyol methacrylate; and
Component C: a polymer or copolymer that is formed of at least one of Components C1 and C2 described below, or a mixed polymer of the polymer and the copolymer,
Component C1: alkyl acrylate having an alkyl group containing at least one of a hydroxyl group and an acryloyl group, and
Component C2: alkyl methacrylate having an alkyl group containing at least one of a hydroxyl group and an acryloyl group.

Examples of the urethane acrylate and urethane methacrylate of Component A include those containing constituents such as acrylic acid, methacrylic acid, acrylic acid ester, methacrylic acid ester, a polyol, and a diisocyanate. For example, at least one of the urethane acrylate and urethane methacrylate can be produced by using a polyol and at least one monomer selected from acrylic acid, methacrylic acid, acrylic acid ester, and methacrylic acid ester, preparing at least one of a hydroxyacrylate having at least one hydroxyl group and a hydroxymethacrylate having at least one hydroxyl group, and allowing it to react with a diisocyanate. In Component A, one type of urethane acrylate or urethane methacrylate may be used alone, or two types or more of them may be used in combination.

Examples of the acrylic acid ester include alkyl acrylates, cycloalkyl acrylates, etc. Examples of the alkyl acrylates include methyl acrylate, ethyl acrylate, isopropyl acrylate, butyl acrylate, etc. Examples of the cycloalkyl acrylates include cyclohexyl acrylate, etc. Examples of the methacrylic acid ester include alkyl methacrylates, cycloalkyl methacrylates, etc. Examples of the alkyl methacrylates include methyl methacrylate, ethyl methacrylate, isopropyl methacrylate, butyl methacrylate, etc. Examples of the cycloalkyl methacrylates include cyclohexyl methacrylate, etc.

The polyol is a compound having at least two hydroxyl groups. Examples of the polyol include ethylene glycol, 1,3-propylene glycol, 1,2-propylene glycol, diethylene glycol, dipropylene glycol, neopentyl glycol, 1,3-butanediol, 1,4-butanediol, 1,6-hexanediol, 1,9-nonanediol, 1,10-decanediol, 2,2,4-trimethyl-1,3-pentanediol, 3-methyl-1,5-pentanediol, neopentylglycol hydroxypivalate ester, cyclohexane dimethylol, 1,4-cyclohexanediol, spiroglycol, tricyclodecane methylol, hydrogenated bisphenol A, ethylene oxide-added bisphenol A, propylene oxide-added bisphenol A, trimethylolethane, trimethylolpropane, glycerin, 3-methylpentane-1,3,5-triol, pentaerythritol, dipentaerythritol, tripentaerythritol, glucoses, etc.

The diisocyanate to be used herein can be any type of aromatic, aliphatic, or alicyclic diisocyanate. Examples of the diisocyanate include tetramethylene diisocyanate, hexamethylene diisocyanate, isophorone diisocyanate, 2,4-tolylene diisocyanate, 4,4-diphenyl diisocyanate, 1,5-naphthalene diisocyanate, 3,3-dimethyl-4,4-diphenyl diisocyanate, xylene diisocyanate, trimethyl hexamethylene diisocyanate, 4,4-diphenylmethane diisocyanate, and hydrogenated derivatives thereof.

The ratio of Component A to be added is not particularly limited. The use of Component A can improve the flexibility of the resulting hard-coating antiglare layer and adhesion of the resulting hard-coating antiglare layer with respect to the transparent plastic film substrate. From such viewpoints and the viewpoint of hardness of the hard-coating antiglare layer, the ratio of Component A to be added can be, for example, 15 to 55% by weight, preferably 25 to 45% by weight, with respect to the entire resin components in the material for forming the hard-coating antiglare layer. The term “entire resin components” denotes the total amount of Components A, B, and C, or when other resin components are used, a sum of the total amount of the aforementioned three components and the total amount of the resin components. The same applies below.

Examples of Component B include pentaerythritol diacrylate, pentaerythritol triacrylate, pentaerythritol tetraacrylate, dipentaerythritol hexaacrylate, 1,6-hexanediol acrylate, pentaerythritol dimethacrylate, pentaerythritol trimethacrylate, pentaerythritol tetramethacrylate, dipentaerythritol hexamethacrylate, 1,6-hexanediol methacrylate, etc. These can be used alone. Alternatively, two or more of them can be used in combination. Preferred examples of the polyol acrylate include a monomer component containing a polymer of pentaerythritol triacrylate and pentaerythritol tetraacrylate, and a component mixture containing pentaerythritol triacrylate and pentaerythritol tetraacrylate.

The ratio of Component B to be added is not particularly limited. The ratio of Component B to be added is preferably 70 to 180% by weight and more preferably 100 to 150% by weight, with respect to the amount of Component A. When the ratio of Component B to be added is 180% by weight or less with respect to the amount of Component A, the hard-coating antiglare layer to be formed can be effectively prevented from hardening and shrinking. As a result, the hard-coated antiglare film can be prevented from curling and the flexibility thereof can be prevented from deteriorating. When the ratio of Component B to be added is at least 70% by weight with respect to the amount of Component A, the hard-coating antiglare layer to be formed can have further improved hardness and improved scratch resistance.

In Component C, the alkyl groups of Components C1 and C2 are not particularly limited. The alkyl groups can have a carbon number of 1 to 10. The alkyl groups can be of a straight chain. The alkyl groups can be of a branched-chain. For example, Component C can contain a polymer or copolymer containing a repeating unit represented by General Formula (1) indicated below, or a mixture of the polymer and the copolymer.

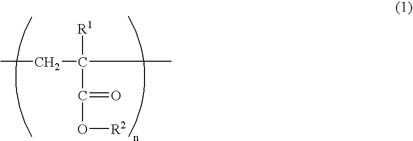

### In General Formula (1), R¹ denotes —H or —CH₃, R² denotes —CH₂CH₂OX or a group that is represented by General Formula (2) indicated below, and X denotes —H or an acryloyl group that is represented by General Formula (3) indicated below.

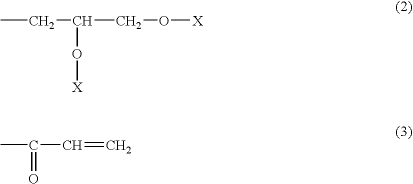

### In General Formula (2), X denotes —H or an acryloyl group that is represented by General Formula (3), and the Xs may be identical to or different from each other.

Examples of Component C include a polymer, a copolymer, and a mixture of the polymer and the copolymer, with the polymer and a copolymer being formed of at least one monomer selected from the group consisting of 2,3-dihydroxypropyl acrylate, 2,3-diacryloyloxypropyl acrylate, 2-hydroxy-3-acryloyloxypropyl acrylate, 2-acryloyloxy-3-hydroxypropyl acrylate, 2,3-dihydroxypropyl methacrylate, 2,3-diacryloyloxypropyl methacrylate, 2-hydroxy-3-acryloyloxypropyl methacrylate, 2-acryloyloxy-3-hydroxypropyl methacrylate, 2-hydroxyethyl acrylate, 2-acryloyloxyethyl acrylate, 2-hydroxyethyl methacrylate, and 2-acryloyloxyethyl methacrylate.

The ratio of Component C to be added is not particularly limited. For instance, the ratio of Component C to be added is preferably 25 to 110% by weight and more preferably 45 to 85% by weight, with respect to the amount of Component A. When the ratio of Component C to be added is 110% by weight or lower with respect to the amount of Component A, the material for forming the hard-coating antiglare layer has excellent coating properties. When the ratio of Component C to be added is at least 25% by weight with respect to the amount of Component A, the hard-coating antiglare layer to be formed can be prevented from hardening and shrinking. As a result, in the hard-coated antiglare film, curling can be controlled.

The fine particles used for forming the hard-coating antiglare layer serve mainly for providing the hard-coating antiglare layer with antiglare properties by forming unevenness at the resulting hard-coating antiglare layer surface. The fine particles can be inorganic or organic fine particles, for example. The inorganic fine particles are not particularly limited. Examples of the inorganic fine particles include fine particles made of silicon oxide, titanium oxide, aluminum oxide, zinc oxide, tin oxide, calcium carbonate, barium sulfate, talc, kaolin, calcium sulfate, etc. The organic fine particles are not particularly limited. Examples thereof include polymethyl methacrylate acrylate resin powder (PMMA fine particles), silicone resin powder, polystyrene resin powder, polycarbonate resin powder, acrylic-styrene resin powder, benzoguanamine resin powder, melamine resin powder, polyolefin resin powder, polyester resin powder, polyamide resin powder, polyimide resin powder, polyethylene fluoride resin powder, etc. One type of the inorganic and organic fine particles can be used alone. Alternatively, two types or more of them can be used in combination.

As described above, the weight average particle size of the fine particles is in the range of 7 to 15 μm. When the weight average particle size of the fine particles exceeds this range, the image sharpness is reduced. When it is smaller than this range, sufficiently high antiglare properties cannot be obtained and glare increases, which are problems. The weight average particle size of the fine particles is preferably in the range of 7.5 to 12 μm and further preferably in the range of 8 to 10 μm. For the measurement of the weight average particle size of the fine particles, for instance, a particle size distribution measurement apparatus (trade name: COULTER MULTISIZER, manufactured by BECKMAN COULTER, INC.) using a pore electrical resistance method is used to measure electrical resistance of an electrolyte corresponding to the volume of the fine particles when the fine particles pass through the pores. Thus, the number and volume of the fine particles are measured and then the weight average particle size is calculated.

The shape of the fine particles is not particularly limited. For instance, they can have a bead-like, substantially spherical shape or can have an indeterminate shape like powder. However, the fine particles preferably have a substantially spherical shape, more preferably a substantially spherical shape with an aspect ratio of 1.5 or lower, and most preferably a spherical shape.

With respect to 100 parts by weight of the curable hard-coating resin, the ratio of the fine particles to be added is preferably 10 to 50 parts by weight, more preferably 15 to 45 parts by weight and further preferably 20 to 35 parts by weight.

The difference obtained by subtracting the refractive index of the fine particles from that of the curable hard-coating resin that has been cured is in the range of −0.06 to −0.01 and 0.01 to 0.06. When the difference between the refractive indices is in the range described above, the hard-coated antiglare film has excellent antiglare properties and prevents glare from occurring while being excellent in image sharpness. The difference between the refractive indices is preferably in the range of −0.05 to −0.01 or 0.01 to 0.05 and more preferably in the range of −0.04 to −0.01 or 0.01 to 0.04.

In the unevenness of the hard-coating antiglare layer surface, the average tilt angle θa can be, for example, in the range of 0.15° to 2.00°, preferably in the range of 0.30° to 1.80°, and more preferably in the range of 0.60° to 1.50°. In the unevenness of the hard-coating antiglare layer surface, the arithmetic average surface roughness Ra can be, for example, in the range of 0.03 to 0.3 μm, preferably in the range of 0.04 to 0.25 μm, and more preferably in the range of 0.06 to 0.2 μm. The average interval Sm between the concaves and convexes of the uneven shape of the hard-coating antiglare layer can be, for example, in the range of 50 to 250 μm, preferably in the range of 75 to 200 μm, and more preferably in the range of 100 to 180 μm. In the present invention, the average tilt angle θa, the arithmetic average surface roughness Ra and the average interval Sm between the concaves and convexes can be adjusted by suitably selecting the type of curable hard-coating resin, the thickness of the hard-coating antiglare layer, the type of fine particles, the weight average particle size of the fine particles, etc. Any person skilled in the art can obtain the average tilt angle θa, the arithmetic average surface roughness Ra and the average interval Sm between the concaves and convexes in the predetermined ranges of the present invention without carrying out an excessive amount of trial and error.

In the present invention, the average tilt angle θa is a value defined by Expression (1) indicated below. The average tilt angle θa is a value measured by the method described later in the section of Examples.

Average tilt angle θa=tan⁻¹Δa (1)

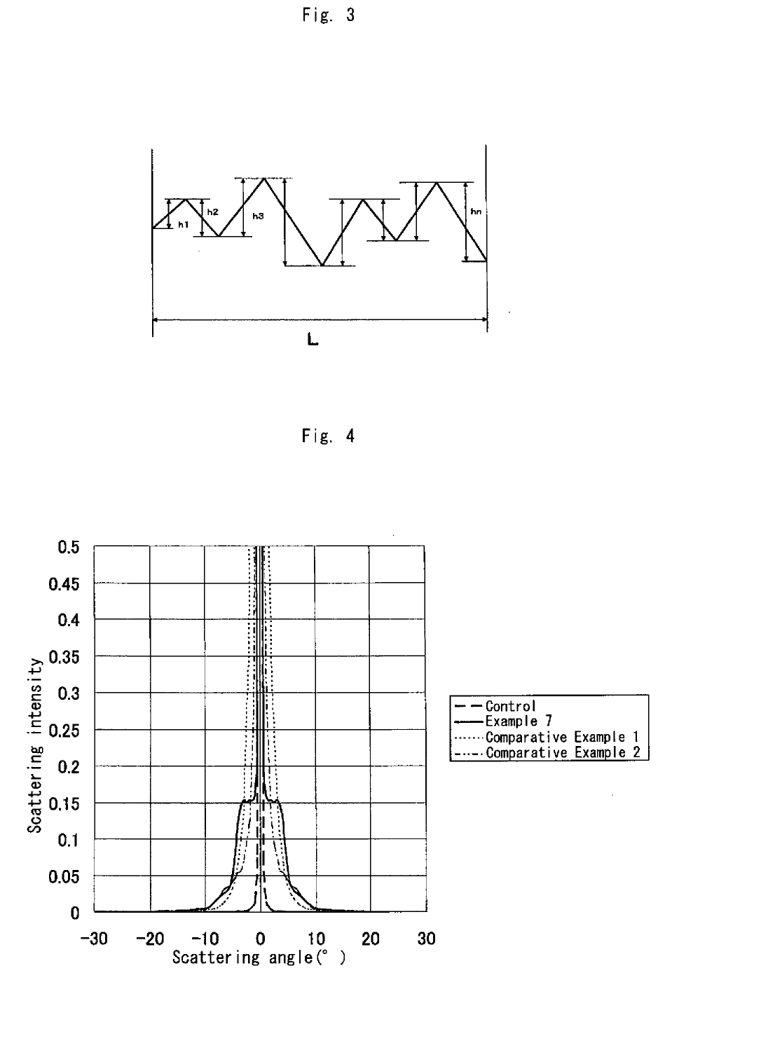

In Expression (1) described above, as indicated in Expression (2) below, Δa denotes a value obtained by dividing the sum total (h1+h2+h3 . . . +hn) of the differences (heights h) between adjacent peaks and the lowest point of the trough formed there between by the standard length L of the roughness curve defined in JIS B 0601 (1994 version). The roughness curve is a curve obtained by removing the surface waviness components with longer wavelengths than the predetermined one from the profile curve using a retardation compensation high-pass filter. The profile curve denotes a profile that appears at the cut surface when an object surface was cut in a plane perpendicular to the object surface. FIG. 3 shows examples of the roughness curve, height h, and standard line L.

Δa=(h1+h2+h3 . . . +hn)/L (2)

The arithmetic average surface roughness Ra and the average interval Sm between the concaves and convexes are specified in JIS B 0601 (1994 version) and can be measured by the method of an example described later, for example.

The difference d in refractive index between the transparent plastic film substrate and the hard-coating antiglare layer is preferably at most 0.04. When the difference dis at most 0.04, the interference fringes can be prevented from occurring. The difference dis more preferably at most 0.02.

The thickness of the hard-coating antiglare layer is in the range of 20 to 30 μm. When the thickness is in the above-mentioned range, the hard-coating antiglare layer can have a sufficiently high hardness (for instance, a pencil hardness of at least 4H). Furthermore, the thickness exceeding the above-mentioned range causes problems in that it curls considerably so as to have deteriorated line traveling performance during the formation and further in that antiglare properties are deteriorated. On the other hand, when the thickness is less than the predetermined range described above, there is a problem in that glare cannot be prevented from occurring and thereby the sharpness deteriorates. The thickness of the hard-coating antiglare layer is preferably in the range of 22 to 28 μm and more preferably in the range of 23 to 27 μm.

The hard-coated antiglare film of the present invention can be manufactured by, for example, preparing a material for forming a hard-coating antiglare layer including the fine particles, the curable hard-coating resin and a solvent; forming a coating film by applying the material for forming the hard-coating antiglare layer onto at least one surface of the transparent plastic film substrate; and forming the hard-coating antiglare layer by curing the coating film.

The solvent is not particularly limited. Examples of the solvent include dibutyl ether, dimethoxymethane, dimethoxyethane, diethoxyethane, propylene oxide, 1,4-dioxane, 1,3-dioxolane, 1,3,5-trioxane, tetrahydrofuran, acetone, methyl ethyl ketone, diethyl ketone, dipropyl ketone, diisobutyl ketone, cyclopentanone, cyclohexanone, methylcyclohexanone, ethyl formate, propyl formate, n-pentyl formate, methyl acetate, ethyl acetate, methyl propionate, ethyl propionate, n-pentyl acetate, acetyl acetone, diacetone alcohol, methyl acetoacetate, ethyl acetoacetate, methanol, ethanol, 1-propanol, 2-propanol, 1-butanol, 2-butanol, 1-pentanol, 2-methyl-2-butanol, cyclohexanol, isobutyl acetate, methyl isobutyl ketone (MIBK), 2-octanone, 2-pentanone, 2-hexanone, 2-heptanone, 3-heptanone, ethylene glycol monoethyl ether acetate, ethylene glycol monoethyl ether, ethylene glycol monobutyl ether, ethylene glycol monomethyl ether, propylene glycol monomethyl ether acetate, propylene glycol monomethyl ether, etc. One of these solvents or any combination of two or more of these solvents may be used. From the viewpoints of improving the adhesion between the transparent plastic film substrate and the hard-coating antiglare layer, the solvent contains ethyl acetate whose ratio to the total weight of solvent is preferably at least 50% by weight, more preferably at least 60% by weight, and most preferably at least 70% by weight. The type of the solvent to be used in combination with the ethyl acetate is not particularly limited. Examples of the solvent include butyl acetate, methyl ethyl ketone, ethylene glycol monobutyl ether, propylene glycol monomethyl ether, etc.

Various types of leveling agents can be added to the material for forming the hard-coating antiglare layer. The leveling agent may be, for example, a fluorochemical or silicone leveling agent, preferably a silicone leveling agent. Examples of the silicon leveling agent include a reactive silicone, polydimethylsiloxane, polyether-modified polydimethylsiloxane, polymethylalkylsiloxane, etc. Among these silicone leveling agents, the reactive silicone is particularly preferred. The reactive silicone added can impart lubricity to the surface and produce continuous scratch resistance over a long period of time. In the case of using a reactive silicone containing a hydroxyl group, when an antireflection layer (a low refractive index layer) containing a siloxane component is formed on the hard-coating antiglare layer, the adhesion between the antireflection layer and the hard-coating antiglare layer is improved.

The amount of the leveling agent to be added can be, for example, at most 5 parts by weight, preferably in the range of 0.01 to 5 parts by weight, with respect to 100 parts by weight of entire resin components.

If necessary, the material for forming the hard-coating antiglare layer may contain a pigment, a filler, a dispersing agent, a plasticizer, an ultraviolet absorbing agent, a surfactant, an antioxidant, a thixotropy-imparting agent, or the like, as long as the performance is not degraded. One of these additives may be used alone, or two or more of these additives may be used together.

The material for forming the hard-coating antiglare layer can contain any conventionally known photopolymerization initiator. Examples of the applicable photopolymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N, N,N′,N′-tetramethyl-4,4′-diaminobenzophenone, 1-(4-isopropylphenyl)-2-hydroxy-2-methylpropane-1-one, and other thioxanthone compounds.

The material for forming the hard-coating antiglare layer may be applied onto the transparent plastic film substrate by any coating method such as fountain coating, die coating, spin coating, spray coating, gravure coating, roll coating, bar coating, etc.

The material for forming the hard-coating antiglare layer is applied to form a coating film on the transparent plastic film substrate and then the coating film is cured. Preferably, the coating film is dried before being cured. The drying can be carried out by, for example, allowing it to stand, air drying by blowing air, drying by heating, or a combination thereof.

While the coating film formed of the material for forming the hard-coating antiglare layer may be cured by any method, ionizing radiation curing is preferably used. While any type of activation energy may be used for such curing, ultraviolet light is preferably used. Preferred examples of the energy radiation source include high-pressure mercury lamps, halogen lamps, xenon lamps, metal halide lamps, nitrogen lasers, electron beam accelerators, and radioactive elements. The amount of irradiation with the energy radiation source is preferably 50 to 5000 mJ/cm² in terms of accumulative exposure at an ultraviolet wavelength of 365 nm. When the amount of irradiation is at least 50 mJ/cm², the material for forming the hard-coating antiglare layer can be sufficiently cured and the resulting hard-coating antiglare layer also has a sufficiently high hardness. When the amount of irradiation is at most 5000 mJ/cm², the resulting hard-coating antiglare layer can be prevented from being colored and thereby can have improved transparency.

As described above, a hard-coated antiglare film of the present invention can be manufactured by forming the hard-coating antiglare layer on at least one surface of the transparent plastic film substrate. The hard-coated antiglare film of the present invention can be manufactured by manufacturing methods other than that described above. The hard-coated antiglare film of the present invention can have a pencil hardness of at least 4H, for example.

FIG. 1 is a cross-sectional view schematically showing an example of the hard-coated antiglare film of the present invention. As shown in FIG. 1, a hard-coated antiglare film 4 in this example includes a transparent plastic film substrate 1 and a hard-coating antiglare layer 2 is formed on one surface of the transparent plastic film substrate 1. The hard-coating antiglare layer 2 contains fine particles 3 and the surface of the hard-coating antiglare layer 2 is provided with unevenness due to the fine particles 3. In this example, the hard-coating antiglare layer 2 is formed on one surface of the transparent plastic film substrate 1. However, the present invention is not limited to this. A hard-coated antiglare film can include a transparent plastic film substrate 1 and hard-coating antiglare layers 2, each of which is formed on each surface of the transparent plastic film substrate 1. The hard-coating antiglare layer 2 in this example is a monolayer. However, the present invention is not limited to this. The hard-coating antiglare layer 2 may have a multilayer structure in which two or more layers are stacked together.

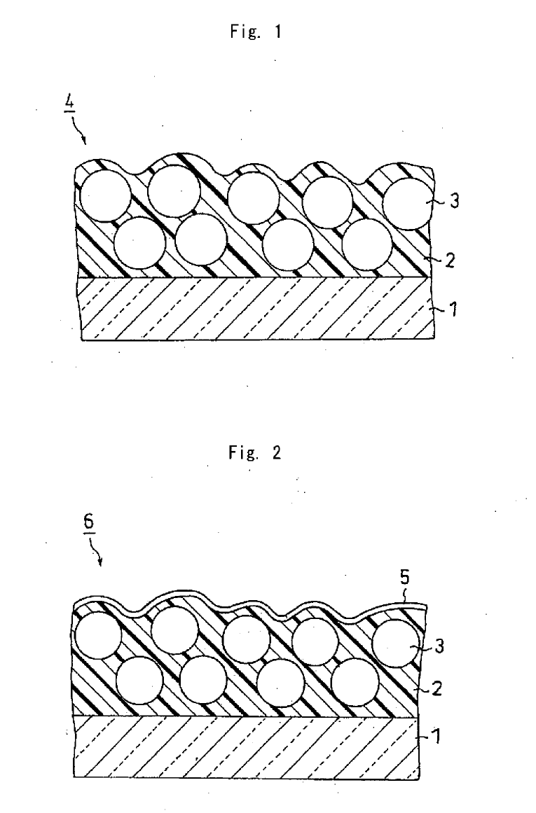

In the hard-coated antiglare film of the present invention, an antireflection layer (a low refractive index layer) may be formed on the hard-coating antiglare layer. FIG. 2 is a cross-sectional view schematically showing an example of a hard-coated antiglare film of the present invention including the antireflection layer. As shown in FIG. 2, a hard-coated antiglare film 6 in this example has a structure in which a hard-coating antiglare layer 2 contains fine particles 3 and is formed on one surface of the transparent plastic film substrate 1 and an antireflection layer 5 is formed on the hard-coating antiglare layer 2. Light incident on an object undergoes reflection at the interface, absorption and scattering in the interior, and any other phenomena repeatedly until it goes through the object and reaches the back side. For example, light reflection at the interface between air and a hard-coating antiglare layer is one of the factors in the reduction in visibility of the image on an image display equipped with the hard-coated antiglare film. The antireflection layer reduces such surface reflection. In the hard-coated antiglare film 6 shown in FIG. 2, the hard-coating antiglare layer 2 and the antireflection layer 5 are formed on one surface of the transparent plastic film substrate 1. However, the present invention is not limited to this. In a hard-coated antiglare film of the present invention, the hard-coating antiglare layer 2 and the antireflection layer 5 may be formed on both surfaces of the transparent plastic film substrate 1. In the hard-coated antiglare film 6 shown in FIG. 2, the hard-coating antiglare layer 2 and the antireflection layer 5 each are a monolayer. However, the present invention is not limited to this. The hard-coating antiglare layer 2 and the antireflection layer 5 each may have a multilayer structure in which at least two layers are stacked together.

In the present invention, the antireflection layer is a thin optical film having a strictly controlled thickness and refractive index, or a laminate including at least two layers of the thin optical films that are stacked together. In the antireflection layer, the antireflection function is produced by allowing opposite phases of incident light and reflected light to cancel each other out based on interference of light. The antireflection function should be produced in the visible light wavelength range of 380 to 780 nm, and the visibility is particularly high in the wavelength range of 450 to 650 nm. Preferably, the antireflection layer is designed to have a minimum reflectance at the center wavelength 550 nm of the range.

When the antireflection layer is designed based on interference of light, the interference effect can be enhanced by a method of increasing the difference in refractive index between the antireflection layer and the hard-coating antiglare layer. Generally, in an antireflection multilayer including two to five thin optical layers (each with strictly controlled thickness and refractive index) that are stacked together, components with different refractive indices from each other are used to form a plurality of layers with a predetermined thickness. Thus, the antireflection layer can be optically designed at a higher degree of freedom, the antireflection effect can be enhanced, and in addition, the spectral reflection characteristics can be made flat in the visible light range. Since each layer of the thin optical film must be precise in thickness, a dry process such as vacuum deposition, sputtering, CVD, etc. is generally used to form each layer.

For the antireflection multilayer, a two-layer laminate is preferred, including a high-refractive-index titanium oxide layer (refractive index: about 1.8) and a low-refractive-index silicon oxide layer (refractive index: about 1.45) formed on the titanium oxide layer. A four-layer laminate is more preferable wherein a silicon oxide layer is formed on a titanium oxide layer, another titanium oxide is formed thereon, and then another silicon oxide layer is formed thereon. The formation of the antireflection layer of such a two- or four-layer laminate can evenly reduce reflection over the visible light wavelength range (for example, 380 to 780 nm).

The antireflection effect can also be produced by forming a thin monolayer optical film (an antireflection layer) on the hard-coating antiglare layer. The antireflection monolayer is generally formed using a coating method such as a wet process, for example, fountain coating, die coating, spin coating, spray coating, gravure coating, roll coating, or bar coating.

Examples of the material for forming an antireflection monolayer include: resin materials such as UV-curable acrylic resins; hybrid materials such as a dispersion of inorganic fine particles such as colloidal silica in a resin; and sol-gel materials containing metal alkoxide such as tetraethoxysilane and titanium tetraethoxide. Preferably, the material contains a fluorine group to impart anti-fouling surface properties. In terms of, for example, scratch resistance, the material preferably contains a large amount of an inorganic component, and the sol-gel materials are more preferable. Partial condensates of the sol-gel materials can be used.

The antireflection layer (the low-refractive-index layer) may contain an inorganic sol for increasing film strength. The inorganic sol is not particularly limited. Examples thereof include silica, alumina, magnesium fluoride, etc. Particularly, silica sol is preferred. The amount of the inorganic sol to be added can be, for example, in the range of 10 to 80 parts by weight, based on 100 parts by weight of the total solids of the material for forming the antireflection layer. The size of the inorganic fine particles in the inorganic sol is preferably in the range of 2 to 50 nm, more preferably 5 to 30 nm.

The material for forming the antireflection layer preferably contains hollow spherical silicon oxide ultrafine particles. The silicon oxide ultrafine particles have preferably an average particle size of 5 to 300 nm, more preferably 10 to 200 nm. The silicon oxide ultrafine particles are in the form of hollow spheres each including a pore-containing outer shell in which a hollow is formed. The hollow contains at least one of a solvent and a gas that has been used for preparing the ultrafine particles. A precursor substance for forming the hollow of the ultrafine particle preferably remains in the hollow. The thickness of the outer shell is preferably in the range of about 1 to about 50 nm and in the range of approximately 1/50 to ⅕ of the average particle size of the ultrafine particles. The outer shell preferably includes a plurality of coating layers. In the ultrafine particles, the pore is preferably blocked, and the hollow is preferably sealed with the outer shell. This is because the antireflection layer holding a porous structure or a hollow of the ultrafine particles can have a reduced refractive index of the antireflection layer. The method of producing such hollow spherical silicon oxide ultrafine particles is preferably a method of producing silica fine particles as disclosed in JP-A No. 2000-233611, for example.

In the process of forming the antireflection layer (the low-refractive-index layer), while drying and curing may be performed at any temperature, they are preferably performed at a temperature of, for example, 60 to 150° C., preferably 70 to 130° C., for a time period of, for instance, 1 minute to 30 minutes, preferably 1 minute to 10 minutes in view of productivity. After drying and curing, the layer may be further heated, so that a hard-coated antiglare film of high hardness including an antireflection layer can be obtained. While the heating may be performed at any temperature, it is preferably performed at a temperature of, for example, 40 to 130° C., preferably 50 to 100° C., for a time period of, for instance, 1 minute to 100 hours, more preferably at least 10 hours in terms of improving scratch resistance. The temperature and the time period are not limited to the above ranges. The heating can be performed by a method using a hot plate, an oven, a belt furnace, or the like.

When the hard-coated antiglare film including the antireflection layer is attached to an image display, the antireflection layer may frequently serve as the uppermost surface and thus tends to be susceptible to stains from the external environment. Stains are more conspicuous on the antireflection layer than on, for instance, a simple transparent plate. In the antireflection layer, for example, deposition of stains such as fingerprints, thumbmarks, sweat, and hairdressings change the surface reflectance, or the deposition stands out whitely to make the displayed content unclear. Preferably, an antistain layer formed of a fluoro-silane compound, a fluoro-organic compound, or the like is layered on the antireflection layer in order to impart the functions of antideposition and easy elimination of the stains.

With respect to the hard-coated antiglare film of the present invention, it is preferable that at least one of the transparent plastic film substrate and the hard-coating antiglare layer be subjected to a surface treatment. When the surface treatment is performed on the transparent plastic film substrate, adhesion thereof to the hard-coating antiglare layer, the polarizer, or the polarizing plate further improves. When the surface treatment is performed on the hard-coating antiglare layer, adhesion thereof to the antireflection layer, the polarizer, or the polarizing plate further improves. The surface treatment can be, for example, a low-pressure plasma treatment, an ultraviolet radiation treatment, a corona treatment, a flame treatment, or an acid or alkali treatment. When a triacetyl cellulose film is used for the transparent plastic film substrate, an alkali treatment is preferably used as the surface treatment. This alkali treatment can be carried out by allowing the surface of the triacetyl cellulose film to come into contact with an alkali solution, washing it with water, and drying it. The alkali solution can be a potassium hydroxide solution or a sodium hydroxide solution, for example. The normal concentration (molar concentration) of the hydroxide ions of the alkali solution is preferably in the range of 0.1 N (mol/L) to 3.0 N (mol/L), more preferably 0.5 N (mol/L) to 2.0 N (mol/L).

In a hard-coated antiglare film including the transparent plastic film substrate and the hard-coating antiglare layer formed on one surface of the transparent plastic film substrate, for the purpose of preventing curling, the surface opposite to the surface with the hard-coating antiglare layer formed thereon may be subjected to a solvent treatment. The solvent treatment can be carried out by allowing the transparent plastic film substrate to come into contact with a dissolvable or swellable solvent. With the solvent treatment, the transparent plastic film substrate can have a tendency to curl toward the other surface, which can cancel a force causing the transparent plastic film substrate with the hard-coating antiglare layer to curl toward the hard-coating layer side, and thus can prevent curling. Similarly, in the hard-coated antiglare film including the transparent plastic film substrate and the hard-coating antiglare layer formed on one surface of the transparent plastic film substrate, for the purpose of preventing curling, a transparent resin layer may be formed on the other surface. The transparent resin layer can be, for example, a layer that is mainly composed of a thermoplastic resin, a radiation-curable resin, a thermo-setting resin, or any other reactive resin. In particular, a layer mainly composed of a thermoplastic resin is preferred.

The transparent plastic film substrate side of the hard-coated antiglare film of the present invention is generally bonded to an optical component for use in a LCD or ELD via a pressure-sensitive adhesive or an adhesive. Before the bonding, the transparent plastic film substrate surface may also be subjected to various surface treatments as described above.

For example, the optical component can be a polarizer or a polarizing plate. A polarizing plate including a polarizer and a transparent protective film formed on one or both surfaces of the polarizer may be used. If the transparent protective film is formed on both surfaces of the polarizer, the front and rear transparent protective films may be made of the same material or different materials. Polarizing plates are generally placed on both surfaces of a liquid crystal cell. Polarizing plates may be arranged such that the absorption axes of two polarizing plates are substantially perpendicular to each other.

Next, an optical device including a hard-coated film of the present invention stacked therein is described using a polarizing plate as an example. The hard-coated film of the present invention and a polarizer or polarizing plate may be laminated with an adhesive or a pressure-sensitive adhesive to form a polarizing plate having the function according to the invention.

The polarizer is not particularly limited. Examples of the polarizer include: a film that is uniaxially stretched after a hydrophilic polymer film, such as a polyvinyl alcohol type film, a partially formalized polyvinyl alcohol type film, an ethylene-vinyl acetate copolymer type partially saponified film, etc., allowed to adsorb dichromatic substances such as iodine and a dichromatic dye; and polyene type oriented films, such as a dehydrated polyvinyl alcohol film, a dehydrochlorinated polyvinyl chloride film, etc. A polarizer formed of a polyvinyl alcohol type film and a dichromatic material such as iodine is preferred because it has a high polarization dichroic ratio. Although the thickness of the polarizer is not especially limited, the thickness of about 5 to 80 μm may be used.

A polarizer that is uniaxially stretched after a polyvinyl alcohol type film is dyed with iodine can be produced by dipping and dyeing a polyvinyl alcohol type film in an aqueous solution of iodine and then stretching it by 3 to 7 times the original length. The aqueous solution of iodine may contain boric acid, zinc sulfate, zinc chloride, etc., if necessary. Separately, the polyvinyl alcohol type film may be dipped in an aqueous solution containing boric acid, zinc sulfate, zinc chloride, etc. Furthermore, before dyeing, the polyvinyl alcohol type film may be dipped in water and rinsed if needed. Rinsing the polyvinyl alcohol type film with water allows soils and blocking inhibitors on the polyvinyl alcohol type film surface to be washed off and also provides an effect of preventing non-uniformity, such as unevenness of dyeing, that may be caused by swelling the polyvinyl alcohol type film. Stretching may be applied after dyeing with iodine or may be applied concurrently with dyeing, or conversely, dyeing with iodine may be applied after stretching. Stretching can be carried out in aqueous solutions, such as boric acid, potassium iodide, etc. or in water baths.

The transparent protective film formed on one or both surfaces of the polarizer preferably is excellent in transparency, mechanical strength, thermal stability moisture-blocking properties, retardation value stability, or the like. Examples of the material for forming the transparent protective film include the same materials as those used for the transparent plastic film substrate.

Moreover, the polymer films described in JP-A No. 2001-343529 (WO01/37007) also can be used as the transparent protective film. The polymer films described in JP-A No. 2001-343529 are formed of, for example, resin compositions including (A) thermoplastic resins having at least one of a substituted imide group and a non-substituted imide group in the side chain thereof, and (B) thermoplastic resins having at least one of a substituted phenyl group and a non-substituted phenyl group and a nitrile group in the side chain thereof. Examples of the polymer films formed of the resin compositions described above include one formed of a resin composition including: an alternating copolymer containing isobutylene and N-methyl maleimide; and an acrylonitrile-styrene copolymer. The polymer film can be produced by extruding the resin composition in the form of film. The polymer film exhibits a small retardation and a small photoelastic coefficient and thus can eliminate defects such as unevenness due to distortion when a protective film or the like used for a polarizing plate. The polymer film also has low moisture permeability and thus has high durability against moisture penetration.

In terms of polarizing properties, durability, and the like, cellulose resins such as triacetyl cellulose and norbornene resins are preferably used for the transparent protective film. Examples of the transparent protective film that are commercially available include FUJITAC (trade name) manufactured by Fuji Photo Film Co., Ltd., ZEONOA (trade name) manufactured by Nippon Zeon Co., Ltd., and ARTON (trade name) manufactured by JSR Corporation.

The thickness of the transparent protective film is not particularly limited. It can be, for example, in the range of 1 to 500 μm from the viewpoints of strength, workability such as a handling property, a thin layer property, etc. In the above range, the transparent protective film can mechanically protect a polarizer and can prevent a polarizer from shrinking and retain stable optical properties even when exposed to high temperature and high humidity. The thickness of the transparent protective film is preferably in the range of 5 to 200 μm and more preferably 10 to 150 μm.

The polarizing plate in which the hard-coated antiglare film is stacked is not particularly limited. The polarizing plate may be a laminate of the hard-coated film, the transparent protective film, the polarizer, and the transparent protective film that are stacked in this order or a laminate of the hard-coated film, the polarizer, and the transparent protective film that are stacked in this order.

Hard-coated antiglare films of the present invention and various optical devices, such as polarizing plates, including the hard-coated antiglare films can be preferably used in various image displays such as a liquid crystal display, etc. The liquid crystal display of the present invention can have the same configuration as those of conventional liquid crystal displays except for including a hard-coated film of the present invention. The liquid crystal display of the present invention can be manufactured by suitably assembling several parts such as a liquid crystal cell, optical components such as a polarizing plate, and, if necessity, a lighting system (for example, a backlight), and incorporating a driving circuit, for example. The liquid crystal cell is not particularly limited. The liquid crystal cell can be of any type such as TN type, STN type, π type, etc.

In the present invention, the configurations of liquid crystal displays are not particularly limited. The liquid crystal displays of the present invention include, for example, one in which the optical device is disposed on one side or both sides of a liquid crystal cell, one in which a backlight or a reflector is used for a lighting system, etc. In these liquid crystal displays, the optical device of the present invention can be disposed on one side or both sides of the liquid crystal cell. When disposing the optical devices in both the sides of the liquid crystal cell, they may be identical to or different from each other. Furthermore, various optical components and optical parts such as a diffusion plate, an antiglare layer, an antireflection film, a protective plate, a prism array, a lens array sheet, an optical diffusion plate, backlight, etc. may be disposed in the liquid crystal displays.

### EXAMPLES

Next, examples of the present invention are described together with comparative examples. However, the present invention is not limited by the following examples and comparative examples.

### Example 1

A resin material (GRANDIC PC1097 (trade name), manufactured by DAINIPPON INK AND CHEMICALS, INCORPORATED, with a solid concentration of 66% by weight) was prepared. The resin material contained Component A, Component B, Component C, a photopolymerization initiator, and a mixed solvent described below. Then 10 parts by weight of PMMA particles (MX1000 (trade name), manufactured by SOKEN CHEMICAL & ENGINEERING CO., LTD., with a refractive index of 1.49) whose weight average particle size was 10 μm, and 0.1 part by weight of a leveling agent (GRANDIC PC-F479 (trade name), manufactured by DAINIPPON INK AND CHEMICALS, INCORPORATED) were added and mixed to 100 parts by weight of solid content of the resin material described above. This mixture was diluted with a solvent (ethyl acetate) in such a manner that a solid concentration of 55% by weight was obtained. Thus a material for forming a hard-coating antiglare layer was prepared. The material for forming a hard-coating antiglare layer was applied onto a transparent plastic film substrate (a triacetyl cellulose film with a thickness of 80 μm and a refractive index of 1.48) with a bar coater. Thus a coating film was formed. After the application, it was heated at 100° C. for one minute and thus the coating film was dried. Thereafter, it was irradiated with ultraviolet light at an accumulated light intensity of 300 mJ/cm² using a high pressure mercury lamp and thereby the coating film was cured to form a 25-μm thick hard-coating antiglare layer. Thus an intended hard-coated antiglare film was obtained.
Component A: isophorone diisocyanate type urethane acrylate (100 parts by weight)
Component B: dipentaerythritol hexaacrylate (38 parts by weight), pentaerythritol tetraacrylate (40 parts by weight), and pentaerythritol triacrylate (15.5 parts by weight)
Component C: a polymer or copolymer having a repeating unit represented by General Formula (1) described above, or a mixture of the polymer and copolymer (30 parts by weight)
Photopolymerization initiator: 1.8 parts by weight of IRGACURE 184 (trade name, manufactured by CIBA SPECIALTY CHEMICALS), and 5.6 parts by weight of Lucirin type photopolymerization initiator
Mixed solvent: butyl acetate:ethyl acetate (weight ratio)=3:4

### Example 2

An intended hard-coated antiglare film was obtained in the same manner as in Example 1 except that the number of parts of fine particles to be added was changed to 30 parts by weight with respect to 100 parts by weight of solid content of resin raw material.

### Example 3

An intended hard-coated antiglare film was obtained in the same manner as in Example 1 except that the number of parts of fine particles to be added was changed to 50 parts by weight with respect to 100 parts by weight of solid content of resin raw material.

### Example 4

An intended hard-coated antiglare film was obtained in the same manner as in Example 1 except that the fine particles were changed to acrylic styrene particles with a weight average particle size of 10 μm (N1055 (trade name) manufactured by SOKEN CHEMICAL & ENGINEERING CO., LTD., with a refractive index of 1.55).

### Example 5

An intended hard-coated antiglare film was obtained in the same manner as in Example 4 except that the number of parts of fine particles to be added was changed to 30 parts by weight with respect to 100 parts by weight of solid content of resin raw material.

### Example 6

An intended hard-coated antiglare film was obtained in the same manner as in Example 1 except that the fine particles were changed to acrylic styrene particles with a weight average particle size of 8 μm (XX-48AA (trade name) manufactured by SEKISUI PLASTICS CO., LTD., with a refractive index of 1.545) and the number of parts thereof to be added was changed to 23 parts by weight.

### Example 7

An intended hard-coated antiglare film was obtained in the same manner as in Example 1 except that the fine particles were changed to acrylic particles with a weight average particle size of 8 μm (MBX-8SSTN (trade name) manufactured by SEKISUI PLASTICS CO., LTD., with a refractive index of 1.49) and the number of parts thereof to be added was changed to 30 parts by weight.

### Comparative Example 1

A material for forming a hard-coating antiglare layer was prepared by diluting the following components with toluene so as to have a solid content concentration of 45% by weight: 100 parts by weight of ultraviolet curable resin composed of isocyanurate triacrylate, pentaerythritol triacrylate, dipentaerythritol hexaacrylate, and isophorone diisocyanate polyurethane, 0.5 part by weight of leveling agent (DEFENSA MCF323), 6.5 parts by weight of silicon oxide particles with a weight average particle size of 1.3 μm (SYLOPHOBIC 100, manufactured by FUJI SILYSIA CHEMICAL LTD.), 7.5 parts by weight of silicon oxide particles with a weight average particle size of 2.5 μm (SYLOPHOBIC 702, manufactured by FUJI SILYSIA CHEMICAL LTD.), and 5 parts by weight of IRGACURE 184 (trade name), (manufactured by CIBA SPECIALTY CHEMICALS) that was used as a photopolymerization initiator. This material for forming a hard-coating antiglare layer was applied to a transparent plastic film substrate identical to that used in Example 1, with a bar coater. This was heated at 100° C. for three minutes and thereby the coating film was dried. Thereafter, it was irradiated with ultraviolet light at an accumulated light intensity of 300 mJ/cm² using a metal halide lamp and thereby the coating film was cured to form a 3-μm thick hard-coating antiglare layer. Thus an intended hard-coated antiglare film was obtained.

### Comparative Example 2

A material for forming a hard-coating antiglare layer was prepared by diluting the following components with toluene so as to have a solid content concentration of 45% by weight: 100 parts by weight of ultraviolet curable resin composed of isocyanurate triacrylate, pentaerythritol triacrylate, dipentaerythritol hexaacrylate, and isophorone diisocyanate polyurethane, 0.5 part by weight of leveling agent (DEFENSA MCF323), 14 parts by weight of polystyrene particles with a weight average particle size of 3.5 μm (SXS350H (trade name), manufactured by SOKEN CHEMICAL & ENGINEERING CO., LTD.), and 5 parts by weight of IRGACURE 184 (trade name), (manufactured by CIBA SPECIALTY CHEMICALS) that was used as a photopolymerization initiator. This material for forming a hard-coating antiglare layer was applied to a transparent plastic film substrate identical to that used in Example 1, with a bar coater. This was heated at 100° C. for three minutes and thereby the coating film was dried. Thereafter, it was irradiated with ultraviolet light at an accumulated light intensity of 300 mJ/cm² using a metal halide lamp and thereby the coating film was cured to form a 5-μm thick hard-coating antiglare layer. Thus an intended hard-coated antiglare film was obtained.

### EVALUATION

In the respective examples and comparative examples, various characteristics were evaluated or measured by the following methods.

### Thickness of Hard-Coating Antiglare Layer

A thickness gauge (microgauge type manufactured by MITUTOYO CORPORATION) was used to measure the total thickness of the hard-coated antiglare film. The thickness of the transparent plastic film substrate was subtracted from the total thickness. Thus the thickness of the hard-coating antiglare layer was calculated.

### Haze

A haze meter HR300 (trade name, manufactured by MURAKAMI COLOR RESEARCH LABORATORY) was used to measure haze according to JIS K 7136 (1981 version) (haze (cloudiness)).

### Average Tilt Angle θa, Arithmetic Average Surface Roughness Ra, and Average Interval Sm between Concaves and Convexes

A glass sheet (with a thickness of 1.3 mm) manufactured by MATSUNAMI GLASS IND., LTD. was bonded to the surface of the hard-coated antiglare film on which the hard-coating antiglare layer had not been formed, with an adhesive. Then the surface shape of the hard-coating antiglare layer was measured using a high-precision micro figure measuring instrument (trade name: SURFCORDER ET4000, manufactured by KOSAKA LABORATORY LTD.). Thus, the average tilt angle θa, arithmetic average surface roughness Ra, and average interval Sm between concaves and convexes were determined. The high-precision micro figure measuring instrument automatically calculates the average tilt angle θa, arithmetic average surface roughness Ra, and average interval Sm between concaves and convexes.

### Refractive Indices of Transparent Plastic Film Substrate and Hard-Coating Layer (Including No Fine Particles)

The refractive indices of the transparent plastic film substrate and the hard-coating layer (including no fine particles) were measured with an ABBE REFRACTOMETER (trade name: DR-M2/1550) manufactured by ATAGO CO., LTD. by a measuring method specified for the apparatus. The measurement was carried out, with monobromonaphthalene being selected for an intermediate liquid, and with measuring light being allowed to be incident on the measuring planes of the film and the hard-coating layer. The refractive index of the hard-coating layer (including no fine particles) denotes “the refractive index of the curable hard-coating resin that has been cured” in the present invention.

### Refractive Index of Fine Particles

Fine particles were placed on a slide glass, and a refractive index standard solution was dropped on the fine particles. Thereafter, a cover glass was placed thereon. Thus a sample was prepared. The sample was observed with a microscope and thereby the refractive index of the refractive index standard solution that was obtained at the point where the profiles of the fine particles were most difficult to view at the interface with the refractive index standard solution was used as the refractive index of the fine particles.

### Weight Average Particle Size of Fine Particles

By the Coulter counting method, a particle size distribution measurement apparatus (trade name: COULTER MULTISIZER, manufactured by BECKMAN COULTER, INC.) using a pore electrical resistance method was employed to measure electrical resistance of an electrolyte corresponding to the volumes of the fine particles when the fine particles passed through the pores. Thus the number and volume of the fine particles were measured and then the weight average particle size of the fine particles was calculated.

### Antiglare Properties

(1) A black acrylic plate (with a thickness of 2.0 mm, manufactured by MITSUBISHI RAYON CO., LTD.) was bonded to the surface of the hard-coated antiglare film on which the hard-coating antiglare layer had not been formed, with an adhesive. Thus, a sample was prepared that had a back surface with no reflection.
(2) In an office environment (about 1000 Lx) where general displays are used, the antiglare properties of the sample were judged visually according to the following criteria:
A: image reflection is hardly observed,
B: image reflection is observed but has a little effect on visibility,
C: image reflection is observed with no problem in practical use, and
D: image reflection is observed with a problem in practical use.

### Sharpness

(1) A polarizing plate having a smooth surface without unevenness was attached to the panel surface of a notebook computer (trade name: VAIO VGN-SZ71B/B (13.3 inch, WXGA, 1280×800), manufactured by SONY CORPORATION). A pressure-sensitive adhesive was stacked on the surface of the hard-coated antiglare film on which the hard-coating antiglare layer had not been formed, and the surface of the polarizing plate was attached thereto.
(2) A general image was displayed on the notebook computer, and the image sharpness was observed visually in a dark place. The criteria for judgment were as follows:
A: Blurry image but little effect on visibility (the image is sharp)
B: Blurry but no problem in practical use (practically, there is no problem in sharpness)
C: Blurry and considerably deteriorated visibility (the image is unsharp and there is a problem in practical use)

### Glare

(1) A 185-μm polarizing plate was bonded to the surface of a transparent plastic film substrate on which no hard-coating antiglare layer had been formed. Then this was attached to a glass substrate.
(2) The glare degree of a film sample produced on a mask pattern (with an opening ratio of 25%) fixed onto a light table was evaluated visually.
Criteria for Judgment:
A: hardly any glare is observed
B: glare is observed but no problem in practical use
C: white blur is observed

### Weight Average Molecular Weight

The weight average molecular weight was measured by GPC. The measurement conditions for GPC were as follows:
Measuring apparatus: HLC-8120GPC (trade name) manufactured by TOSOH CORPORATION
Columns: G4000H_{XL} (trade name)+G2000H_{XL} (trade name)+G1000H_{XL} (trade name) (each having 7.8 mmφ×30 cm, a total of 90 cm) manufactured by TOSOH CORPORATION
Column temperature: 40° C.
Eluent: tetrahydrofuran
Flow rate: 0.8 ml/min
Inlet pressure: 6.6 MPa
Standard sample: polystyrene

The hard-coated antiglare films thus obtained in Examples 1 to 7 and Comparative Examples 1 and 2 were evaluated for various properties. The results are indicated in Table 1 below. In Table 1 below, the “HC antiglare layer thickness” denotes the thickness of the hard-coating antiglare layer, and the “HC layer refractive index” denotes the refractive index of the hard-coating layer (including no fine particles).

TABLE 1

| | | HC | Fine | | | Differ- | | | | | | | |
|---|---|---|---|---|---|---|---|---|---|---|---|---|---|
| | HC | layer | particles | The | | ence in | | | | | | | |
| | antiglare | refrac- | refrac- | number | Average | refrac- | | Surface | | | Anti- | | |
| | layer | tive | tive | of parts | size of | tive | | Roughness | | | glare | | |
| | thickness | index | index | of | particles | index | | Ra | Sm | θa | Prop- | Sharp- | |
| | (μm) | (R1) | (R2) | particles | (μm) | (R1 − R2) | Haze | (μm) | (μm) | (°) | erties | ness | Glare |
| Example 1 | 25 | 1.53 | 1.49 | 10 | 10 | 0.04 | 25.2 | 0.06 | 110 | 0.33 | C | B | C |
| Example 2 | 25 | 1.53 | 1.49 | 30 | 10 | 0.04 | 55.1 | 0.11 | 130 | 0.72 | B | B | B |
| Example 3 | 25 | 1.53 | 1.49 | 50 | 10 | 0.04 | 67.8 | 0.16 | 100 | 1.31 | B | C | B |
| Example 4 | 25 | 1.53 | 1.55 | 10 | 10 | −0.02 | 16.9 | 0.04 | 170 | 0.22 | C | C | C |
| Example 5 | 25 | 1.53 | 1.55 | 30 | 10 | −0.02 | 44.3 | 0.25 | 190 | 1.06 | A | C | B |
| Example 6 | 25 | 1.53 | 1.54 | 23 | 8 | −0.01 | 25.4 | 0.13 | 130 | 0.78 | B | C | C |
| Example 7 | 25 | 1.53 | 1.49 | 30 | 8 | 0.04 | 50.7 | 0.08 | 80 | 0.83 | B | B | B |
| Comparative | 3 | 1.53 | 1.46 | 6.5/7.5 | 1.3/2.5 | 0.07 | 28.3 | 0.34 | 80 | 3.99 | A | D | D |
| Example 1 | | | | | | | | | | | | | |
| Comparative | 5 | 1.53 | 1.59 | 14 | 3.5 | −0.06 | 43.9 | 0.18 | 99 | 1.47 | B | D | B |
| Example 2 | | | | | | | | | | | | | |

As shown in Table 1, the hard-coated antiglare films of all the examples were excellent in antiglare properties and image sharpness and prevented glare from occurring effectively. On the other hand, the hard-coated antiglare film of Comparative Example 1 had poor sharpness and did not prevent glare from occurring, and the hard-coated antiglare film of Comparative Example 2 had poor sharpness.

Next, with respect to the hard-coated antiglare films of Example 7 and Comparative Examples 1 and 2, the relationship between the scattering angle and scattering intensity was examined using a measuring apparatus (SPECTRAL GONIO PHOTOMETER GP-3 (trade name)) manufactured by OPTEC CO., LTD. Furthermore, as a control, the identical transparent plastic film substrate of Example 1 also was examined for the relationship between the scattering angle and scattering intensity. The results are indicated in a graph in FIG. 4.

As shown in the graph in FIG. 4, the hard-coated antiglare films of the control and Comparative Examples 1 and 2 had high light intensity in the range of about ±4° including 0° (i.e. when viewed from the direction perpendicular to the film surface) but the intensity decreased at angles larger than that and the scattering intensity decreased continuously. On the other hand, in the hard-coated antiglare film of Example 7, as shown in FIG. 4, the light intensity is high at 0° as in the case of, for example, the control, but the scattering intensity is low up to around ±4° and a constant intensity was obtained, and the scattering intensity decreased continuously at angles larger than that. Thus, it is surmised that since the hard-coated antiglare film of the present invention exhibits low scattering intensities at a certain level in the range of angles slightly deviated from 0°, it is excellent in antiglare properties and image sharpness and can prevent glare from occurring. However, this surmise does not limit or specify the present invention by no means.

The hard-coated antiglare film of the present invention is excellent in antiglare properties and image sharpness and can prevent glare from occurring. Accordingly, the hard-coated antiglare film of the present invention can be suitably used for optical members such as polarizing plates, and various image displays such as CRTs, LCDs, PDPs, and ELDs. It has no limitation in application and is applicable across a wide field of uses.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A hard-coated antiglare film, comprising:
a transparent plastic film substrate; and
a hard-coating antiglare layer that is formed on at least one surface of the transparent plastic film substrate and that is formed of fine particles and a curable hard-coating resin,
wherein the hard-coating antiglare layer has a thickness in a range of 20 to 30 μm, the fine particles have a weight average particle size in a range of 7 to 15 μm, and the difference obtained by subtracting a refractive index of the fine particles from that of the curable hard-coating resin that has been cured is in a range of −0.06 to −0.01 or 0.01 to 0.06.

2. The hard-coated antiglare film according to claim 1, wherein the ratio of the fine particles is in a range of 10 to 50 parts by weight with respect to 100 parts by weight of the curable hard-coating resin.

3. The hard-coated antiglare film according to claim 1, wherein the curable hard-coating resin is at least one of thermosetting resin and ionizing radiation curable resin.

4. The hard-coated antiglare film according to claim 1, wherein the fine particles each have a spherical shape.

5. The hard-coated antiglare film according to claim 1, wherein the curable hard-coating resin contains Component A, Component B, and Component C,
wherein Component A is at least one of urethane acrylate and urethane methacrylate,
Component B is at least one of polyol acrylate and polyol methacrylate, and
Component C is a polymer or copolymer that is formed of at least one of Components C1 and C2, or a mixed polymer of the polymer and the copolymer,
wherein Component C1 is alkyl acrylate having an alkyl group containing at least one of a hydroxyl group and an acryloyl group, and Component C2 is alkyl methacrylate having an alkyl group containing at least one of a hydroxyl group and an acryloyl group.

6. The hard-coated antiglare film according to claim 1, further comprising an antireflection layer formed on the hard-coating antiglare layer.

7. The hard-coated antiglare film according to claim 6, wherein the antireflection layer contains hollow spherical silicon oxide ultrafine particles.

8. A polarizing plate comprising a polarizer, further comprising a hard-coated antiglare film according to claim 1.

9. An image display, comprising the hard-coated antiglare film according to claim 1.

10. An image display, comprising the polarizing plate according to claim 8.
